(19) United States
(12) Patent Application Publication
(10) Pub. No.: US 2026/0361657 A1
(43) Pub. Date: Nov. 12, 2026

(54) AUTO-PRIORITIZING VOICE-OVER INTERNET PROTOCOL TRAFFIC

(71) Applicant: Ruckus IP Holdings LLC, Horsham, PA (US)

(72) Inventors: Ankush Chandan, Sunnyvale, CA (US); Shailesh Gupta, Bengaluru (IN); Mayank Sourabh, Bengaluru (IN); Venkateswarlu Konamki, Bengaluru (IN); Syamantak Omer, Bangalore (IN)

(21) Appl. No.: 19/667,919

(22) Filed: May 5, 2026

Related U.S. Application Data
(60) Provisional application No. 63/800,621, filed on May 6, 2025.

(51) Int. Cl. H04L 47/2441; G06F 40/279; H04L 61/4511; H04M 7/00; H04W 88/16

(52) U.S. Cl. CPC H04L 47/2441; G06F 40/279; H04L 61/4511; H04M 7/006; H04W 88/16

(57) ABSTRACT

An electronic device (such as an access point) that automatically prioritizes a type of traffic flow is described. During operation, the electronic device may access (e.g., in memory) or receive, associated with a second electronic device, a query (such as a Domain Name System or DNS query) or a response to the query. Then, based on one or more keywords in the query or the response to the query, the electronic device may identify the type of traffic flow (such Voice-Over Internet Protocol or VoIP traffic). When the type of traffic flow is identified, the electronic device may set a type of priority for the type of traffic flow, such as a voice access category.

### CROSS-REFERENCE TO RELATED APPLICATIONS

The present application claims priority under 35 U.S.C. § 119 to U.S. Provisional Patent Application Serial No. 63/800,621 filed May 6, 2025, the entire content of which is incorporated herein by reference.

### TECHNICAL FIELD

The described embodiments relate to techniques for automatically prioritizing Voice-Over Internet Protocol (VoIP) traffic, such as VoIP traffic associated with an Evolved Packet Data Gateway (ePDG).

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

Recently, the performance of cellular-telephone networks has been improved by selectively conveying cellular voice calls in non-cellular wired and wireless networks. For example, so-called ‘Wi-Fi calling’ offers an ability to make a cellular voice call using a cellular voice stack in a cellular telephone (such as a smartphone) over a Wi-Fi network. This approach works in the same way as a voice call over Long Term Evolution (LTE)/cellular-telephone networks and supports seamless handoff as a user moves between Wi-Fi and cellular coverage areas.

When an electronic device (such as a cellular telephone) of an end user connects to an access point and the electronic device has a Wi-Fi calling feature enabled, the electronic device may attempt to establish a connection to the core network of the cellular operator via the Internet. Note that information used to guide where the electronic device should connect, such as the domain name of the nearest Internet-accessible carrier gateway in a cellular-telephone network, is typically provided by the Subscriber Identification Module (SIM) card for a cellular telephone network. Moreover, cellular-telephone carriers may opt to deploy various gateways within a cloud architecture, thereby enabling the electronic device to be dynamically routed to the nearest one. These carrier gateways (which are sometimes referred to as ‘evolved packet data gateways’ or ePDGs) are usually responsible for terminating numerous Internet Protocol security (IPSec) tunnels from cellular telephones. The IPSec tunnels may ensure security and enable the operator to route customer traffic across untrusted Wi-Fi and Internet connections.

Wi-Fi calling is often important to customers, because many deployments, in venues such as hospitality and education, have low or no cellular telephone coverage. In these scenarios, Wi-Fi calling may play a significant role in offering calling services.

In order to improve the communication performance, the voice traffic in Wi-Fi calling is sometimes prioritized using quality-of-service (QoS). This may improve voice communications when the wireless environment is congested. However, it is often difficult to correctly prioritize voice traffic in Wi-Fi networks. For example, ePDG information, which may be managed by a Wi-Fi calling profile, is usually manually added. Moreover, it usually difficult for network administrators to maintain a list of carrier gateways and many are not familiar with the fully qualified domain names (FQDNs) of the ePDGs used by Internet service providers. When incorrect information is used, the quality of the communication may be degraded, which is frustrating for users.

### SUMMARY

An electronic device that automatically prioritizes a type of traffic flow is described. This electronic device includes an interface circuit that communicates with a second electronic device. During operation, the electronic device accesses or receives, associated with the second electronic device, a query or a response to the query. Then, based on one or more keywords in the query or the response to the query, the electronic device identifies the type of traffic flow. When the type of traffic flow is identified, the electronic device sets a type of priority for the type of traffic flow.

Note that the query or the response to the query may be accessed in memory in or associated with the electronic device. For example, the query or the response to the query may be stored in a Domain Name System (DNS) cache.

Moreover, the type of traffic flow may include a voice-call flow that is conveyed in a wireless local area network (WLAN) that is different from a cellular-telephone network, and the WLAN may be compatible with an IEEE 802.11 communication protocol. For example, the type of traffic may include VoIP traffic.

Furthermore, the electronic device may include an access point.

Additionally, the query may include a DNS query or the response to the query may include a DNS response. More generally, the query may request an IP address of a domain in a network.

In some embodiments, the type of priority may include a voice access category. Consequently, the type of priority may include a highest priority for time-sensitive data.

Note that the one or more keywords may include ‘epdg’ or ‘3gpp.’ For example, the one or more keywords may be included in a FQDN associated with the query or the response to the query.

Moreover, the type of traffic may be identified based at least in part on a port associated with the type of traffic (such as User Datagram Protocol or UDP 500 or 4500). Alternatively, the type of traffic may be identified based at least in part on a presence of information specifying Encapsulating Security Protocol (ESP) for IP version 4 or version 6 (IPv4 or IPv6) in a header in a packet in the type of traffic.

Furthermore, the electronic device may store the query or the response to the query. For example, the query or the response to the query may be stored in the DNS cache.

Additionally, the second electronic device may include a cellular telephone or a DNS server.

In some embodiments, the electronic device may automatically add information about an ePDG to a Wi-Fi calling profile of a user. Moreover, the electronic device may automatically determine the FQDN used by the ePDG.

Another embodiment provides the second electronic device that performs counterpart operations to at least some of the aforementioned operations of the electronic device.

Another embodiment provides a computer-readable storage medium with program instructions for use with one of the electronic device or the second electronic device. When executed by the electronic device or the second electronic device, the program instructions cause the electronic device or the second electronic device to perform at least some of the aforementioned operations in one or more of the preceding embodiments.

Another embodiment provides a method, which may be performed by the electronic device or the second electronic device. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram illustrating an example of communication among electronic devices in accordance with an embodiment of the present disclosure.

FIG. 2 is a flow diagram illustrating an example of a method for automatically prioritizing a type of traffic flow using an electronic device in FIG. 1 in accordance with an embodiment of the present disclosure.

FIG. 3 is a block diagram illustrating an example of communication among an access point, an electronic device and a Domain Name System (DNS) server in accordance with an embodiment of the present disclosure.

FIG. 4 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device (such as an access point) that automatically prioritizes a type of traffic flow is described. During operation, the electronic device may access (e.g., in memory) or receive, associated with a second electronic device, a query (such as a DNS query) or a response to the query. Then, based on one or more keywords in the query or the response to the query, the electronic device may identify the type of traffic flow (such VoIP traffic). When the type of traffic flow is identified, the electronic device may set a type of priority for the type of traffic flow, such as a voice access category.

By automatically prioritizing the type of traffic flow, these communication techniques may improve the QoS of the type of traffic. Notably, the QoS may be improved in congested environments. Moreover, the communication techniques may simplify the operation of networks that convey the type of traffic. For example, it may not be necessary for an operator or network administrator to manually add information about an ePDG to a Wi-Fi calling profile of a user. Moreover, the electronic device may automatically determine the FQDN used by the ePDG. By improving the QoS, the communication techniques may improve the user experience when communicating using the type of traffic, such as VoIP.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi^{®},’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

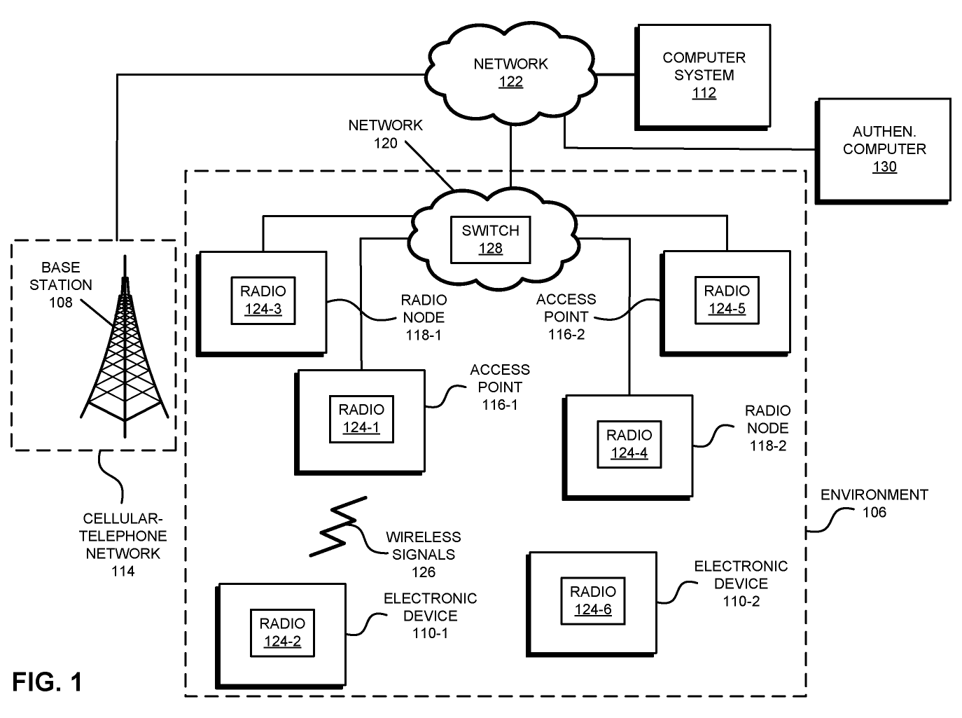

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 (which may be a cloud-based controller that manages and/or configures access points 116, radio nodes 118 and/or switch 128, or that provides cloud-based storage and/or analytical services) and/or authentication computer 130 (such as a RADIUS server and/or an AAA server) using a wired communication protocol (such as Ethernet) via network 120 and/or 122. Note that networks 120 and 122 may be the same or different networks. For example, networks 120 and/or 122 may be: an LAN, an intra-net or the Internet. In some embodiments, network 120 may include one or more routers and/or switches (such as switch 128). In FIG. 1, note that a controller may provide various management, control and cluster functionalities, which may include: network management of access points; performing some of control plane functions (such as roaming); maintaining statistics related to traffic, health of access points, top applications used, number of clients and their capabilities; and/or other functions or functionality.

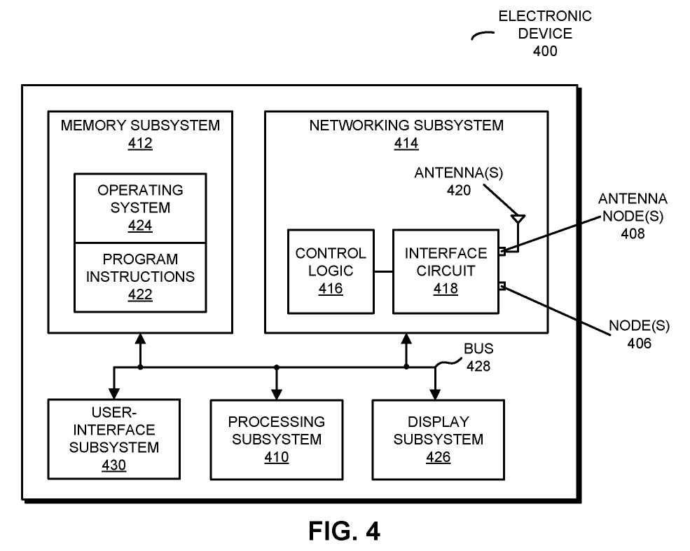

As described further below with reference to FIG. 4, electronic devices 110, computer system 112, access points 116, radio nodes 118, switch 128 and authentication computer 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, it may be difficult to provide high QoS for voice-call traffic (such as VoIP traffic), such as in congested environments. In order to address this problem, an access point (such as access point 116-1) may perform the communication techniques. Notably, access point 116-1 may receive, associated with an electronic device (such as electronic device 110-1), a query. Alternatively or additionally, access point 116-1 may receive a response to the query (e.g., from a DNS server, which is not shown). Then, access point 116-1 may store the query (such as an DNS query) and/or the response to the query (such as a DNS response) in memory in or associated with access point 116-1, such as in a DNS cache.

Moreover, access point 116-1 may access the query or the response to the query. Next, based on one or more keywords in the query or the response to the query, access point 116-1 may identify the type of traffic flow. For example, the type of traffic flow may include a voice-call flow that is conveyed in a WLAN that is different from a cellular-telephone network, and the WLAN may be compatible with an IEEE 802.11 communication protocol. In some embodiments, the type of traffic may include VoIP traffic.

When the type of traffic flow is identified, access point 116-1 may set a type of priority for the type of traffic flow. For example, the type of priority may include a voice access category. Consequently, the type of priority may include a highest priority for time-sensitive data. For example, the type of priority may be specified in a QoS field in packets in the type of traffic flow.

Note that the one or more keywords may include ‘epdg’ or ‘3gpp.’ For example, the one or more keywords may be included in a FQDN associated with the query or the response to the query. In some embodiments, the one or more keywords may specify an ePDG.

Furthermore, the type of traffic may be identified based at least in part on a port associated with the type of traffic (such as User Datagram Protocol or UDP 500 or 4500). Alternatively, the type of traffic may be identified based at least in part on a presence of information specifying ESP for IPv4 or IPv6 in a header in a packet in the type of traffic.

Additionally, access point 116-1 may automatically add information about an ePDG to a Wi-Fi calling profile of a user. In some embodiments, access point 116-1 may automatically determine the FQDN used by the ePDG.

In these ways, the communication techniques may maintain the QoS of VoIP communication. For example, the QoS may be improved in congested environments. Moreover, the communication techniques may simplify the operation of networks that convey the type of traffic. Therefore, it may not be necessary for an operator or network administrator to manually add information about an ePDG to a Wi-Fi calling profile of a user. Moreover, the communication techniques may automatically determine the FQDN used by the ePDG. Consequently, the communication techniques may improve the user experience when communicating using the type of traffic, such as VoIP.

While the preceding discussion illustrated access point 116-1 performing the operations in the communication techniques, in other embodiments at least some of the operations may be performed by or in conjunction with another component in FIG. 1. For example, access point 116-1 may provide the information about the ePDG and/or the FQDN used by the ePDG to a controller (such as computer system 112), which may add the information to the Wi-Fi calling profile or may disseminate the FQDN to one or more computer-network components, such as one or more of the other access points 116.

Moreover, in some embodiments, access point 116-1 may provide the type of priority for the type of traffic flow to a controller, such as computer system 112. Then, computer system 112 may provide the type of priority for the type of traffic flow to one or more of the other access points 116. This may help ensure the QoS of the type of traffic flow, e.g., when electronic device 110-1 roams between or among access points 116.

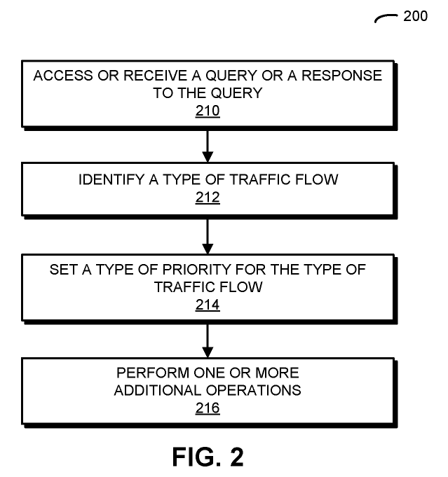

We now describe embodiments of the method. FIG. 2 presents a flow diagram illustrating an example of a method 200 for automatically prioritizing a type of traffic flow, which may be performed by an electronic device, such as access point 116-1 in FIG. 1. During operation, the electronic device may access or receive, associated with a second electronic device, a query or a response to the query (operation 210). Then, based on one or more keywords in the query or the response to the query, the electronic device may identify the type of traffic flow (operation 212). When the type of traffic flow is identified (operation 212), the electronic device may set a type of priority for the type of traffic flow (operation 214).

Note that the query or the response to the query may be accessed in memory in or associated with the electronic device. For example, the query or the response to the query may be stored in a DNS cache.

Moreover, the type of traffic flow may include a voice-call flow that is conveyed in a WLAN that is different from a cellular-telephone network, and the WLAN may be compatible with an IEEE 802.11 communication protocol. For example, the type of traffic may include VoIP traffic.

Furthermore, the query may include a DNS query or the response to the query may include a DNS response. More generally, the query may request an IP address of a domain in a network.

Additionally, the type of priority may include a voice access category. Consequently, the type of priority may include a highest priority for time-sensitive data.

Note that the one or more keywords may include ‘epdg’ or ‘3gpp.’ For example, the one or more keywords may be included in a FQDN associated with the query or the response to the query.

In some embodiments, the type of traffic may be identified based at least in part on a port associated with the type of traffic (such as UDP 500 or 4500). Alternatively, the type of traffic may be identified based at least in part on a presence of information specifying Encapsulating Security Protocol (ESP) for IP version 4 or version 6 (IPv4 or IPv6) in a header in a packet in the type of traffic.

Note that the second electronic device may include a cellular telephone or a DNS server.

In some embodiments, the electronic device may optionally perform one or more optional additional operations (operation 216). For example, the electronic device may store the query or the response to the query. Notably, the query or the response to the query may be stored in the DNS cache.

Moreover, the electronic device may automatically add information about an ePDG to a Wi-Fi calling profile of a user. Furthermore, the electronic device may automatically determine the FQDN used by the ePDG.

Additionally, the type of priority of the type of traffic may be set after an IPSec tunnel has been established for the type of traffic flow.

In some embodiments of method 200, there may be additional or fewer operations. Furthermore, the order of the operations may be changed, and/or two or more operations may be combined into a single operation.

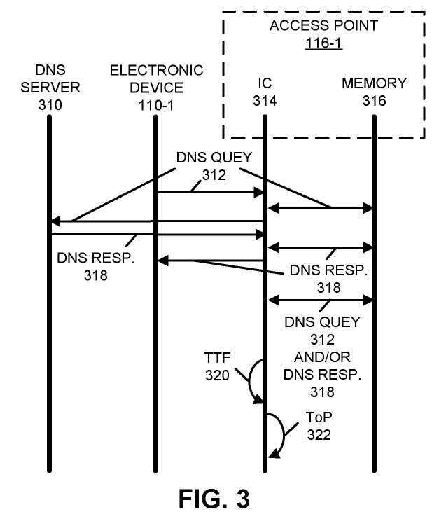

FIG. 3 presents a drawing illustrating an example of communication between electronic device 110-1, access point 116-1, and DNS server 310. Notably, electronic device 110-1 may provide a DNS query 312 to access point 116-1. After receiving DNS query 312, an interface circuit (IC) 314 in access point 116-1 may store DNS query 312 in memory 316 in access point 116-1, such as in a DNS cache. Moreover, interface circuit 314 may provide DNS query 312 to DNS server 310.

Subsequently, DNS server 310 may provide, to access point 116-1, a DNS response 318 to DNS query 312. After receiving DNS query 312, an interface circuit 314 may store DNS response 318 in memory 316, such as in the DNS cache. Moreover, interface circuit 314 may provide DNS response 318 to electronic device 110-1.

Then, interface circuit may access DNS query 312 and/or DNS response 318 in memory 316. Moreover, based on one or more keywords in DNS query 312 and/or DNS response 318, interface circuit 314 may identify a type of traffic flow (TTF) 320. When type of traffic flow 320 is identified, interface circuit 314 may set a type of priority (ToP) 322 for type of traffic flow 320.

While FIG. 3 illustrates some operations using unilateral or bilateral communication (which are, respectively, represented by one-sided and two-sided arrows), in general a given operation in FIG. 3 may involve unilateral or bilateral communication. Moreover, while FIG. 3 illustrates operations being performed sequentially or at different times, in other embodiments at least some of these operations may, at least in part, be performed concurrently or in parallel.

We now further describe the communication techniques. In order to provide a more user/customer friendly way to determine the ePDG associated with VoIP traffic, an access point may auto-learn the ePDG by looking at packets that include ‘epdg’ or ‘3gpp’ in a DNSrequest or a DNS response and caching it. Note that the caching may be performed on a per-session basis (and, thus, may be cleared or erased after the session ends). Once a Wi-Fi calling call is established (e.g., using UDP port 500 or 4500, or a packet header includes ESP(IPv4 or IPv6)), an access point may look at the FQDN associated with the IP address in the DNS cache. When the FQDN has ‘epdg’ or ‘3gpp,’ then the access point may apply a VoIP priority or voice access priority to this traffic flow.

Note that using the communication techniques, a system administrator may not have to know the ePDG gateway uniform resource locator (URL)/Internet Protocol (IP) address to configure the ePDG on a controller and/or to prioritize the Wi-Fi calling traffic as VoIP traffic. Instead, an access point may perform this operation automatically and may apply the VoIP priority. In some embodiments, the access point may automatically recognize the ePDG gateway URL/IP address (e.g., by using the DNS cache on the access point) and may mark the traffic as VoIP.

Thus, the communication techniques may solve two problems. Notably, the system administrator may not need to know the ePDG gateway information to configure on a controller and/or to prioritize the VoIP traffic. Moreover, when there is a change to the ePDG gateway URL/IP address used by the service provider, the access point may still recognize the new ePDG URL and may apply the QoS priority as VoIP. If this automatic prioritization is not performed, the traffic may be prioritized as Best Effort, or Background and quality of the voice call may be degraded.

In some embodiments, the communication techniques may work when the ePDG gateway has either ‘epdg’ or ‘epc’ in the ePDG DNS query, initiated by a mobile or portable electronic device (such as a cellular telephone) of a user. For example: rge ePDG DNS query may include ‘epdg.epc.att.net.’

We now describe embodiments of an electronic device, which may perform at least some of the operations in the communication techniques. FIG. 4 presents a block diagram illustrating an example of an electronic device 400 in accordance with some embodiments, such as one of: base station 108, one of electronic devices 110, computer system 112, one of access points 116, one of radio nodes 118, switch 128 or authentication computer 130. This electronic device includes processing subsystem 410, memory subsystem 412, and networking subsystem 414. Processing subsystem 410 includes one or more devices configured to perform computational operations. For example, processing subsystem 410 can include one or more microprocessors, graphics processing units (GPUs), ASICs, microcontrollers, programmable-logic devices, and/or one or more digital signal processors (DSPs).

Memory subsystem 412 includes one or more devices for storing data and/or instructions for processing subsystem 410 and networking subsystem 414. For example, memory subsystem 412 can include DRAM, static random access memory (SRAM), and/or other types of memory. In some embodiments, instructions for processing subsystem 410 in memory subsystem 412 include: one or more program modules or sets of instructions (such as program instructions 422 or operating system 424, such as Linux, UNIX, Windows Server, or another customized and proprietary operating system), which may be executed by processing subsystem 410. Note that the one or more computer programs, program modules or instructions may constitute a computer-program mechanism. Moreover, instructions in the various modules in memory subsystem 412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 410.

In addition, memory subsystem 412 can include mechanisms for controlling access to the memory. In some embodiments, memory subsystem 412 includes a memory hierarchy that comprises one or more caches coupled to a memory in electronic device 400. In some of these embodiments, one or more of the caches is located in processing subsystem 410.

In some embodiments, memory subsystem 412 is coupled to one or more high-capacity mass-storage devices (not shown). For example, memory subsystem 412 can be coupled to a magnetic or optical drive, a solid-state drive, or another type of mass-storage device. In these embodiments, memory subsystem 412 can be used by electronic device 400 as fast-access storage for often-used data, while the mass-storage device is used to store less frequently used data.

Networking subsystem 414 includes one or more devices configured to couple to and communicate on a wired and/or wireless network (i.e., to perform network operations), including: control logic 416, an interface circuit 418 and one or more antennas 420 (or antenna elements). (While FIG. 4 includes one or more antennas 420, in some embodiments electronic device 400 includes one or more nodes, such as antenna nodes 408, e.g., a metal pad or a connector, which can be coupled to the one or more antennas 420, or nodes 406, which can be coupled to a wired or optical connection or link. Thus, electronic device 400 may or may not include the one or more antennas 420. Note that the one or more nodes 406 and/or antenna nodes 408 may constitute input(s) to and/or output(s) from electronic device 400.) For example, networking subsystem 414 can include a Bluetooth^{TM} networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi^{®} networking system), an Ethernet networking system, and/or another networking system.

Note that a transmit or receive antenna pattern (or antenna radiation pattern) of electronic device 400 may be adapted or changed using pattern shapers (such as directors or reflectors) and/or one or more antennas 420 (or antenna elements), which can be independently and selectively electrically coupled to ground to steer the transmit antenna pattern in different directions. Thus, if one or more antennas 420 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3dB or lower than the peak gain of the given antenna pattern. Thus, the given antenna pattern may include a local maximum (e.g., a primary beam) that directs gain in the direction of electronic device 400 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 400 may use the mechanisms in networking subsystem 414 for performing simple wireless communication between the electronic devices, e.g., transmitting advertising or beacon frames and/or scanning for advertising frames transmitted by other electronic devices as described previously.

Within electronic device 400, processing subsystem 410, memory subsystem 412, and networking subsystem 414 are coupled together using bus 428. Bus 428 may include an electrical, optical, and/or electro-optical connection that the subsystems can use to communicate commands and data among one another. Although only one bus 428 is shown for clarity, different embodiments can include a different number or configuration of electrical, optical, and/or electro-optical connections among the subsystems.

In some embodiments, electronic device 400 includes a display subsystem 426 for displaying information on a display, which may include a display driver and the display, such as a liquid-crystal display, a multi-touch touchscreen, etc.

Moreover, electronic device 400 may include a user-interface subsystem 430, such as: a mouse, a keyboard, a trackpad, a stylus, a voice-recognition interface, and/or another human-machine interface. In some embodiments, user-interface subsystem 430 may include or may interact with a touch-sensitive display in display subsystem 426.

Electronic device 400 can be (or can be included in) any electronic device with at least one network interface. For example, electronic device 400 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 400, in alternative embodiments, different components and/or subsystems may be present in electronic device 400. For example, electronic device 400 may include one or more additional processing subsystems, memory subsystems, networking subsystems, and/or display subsystems. Additionally, one or more of the subsystems may not be present in electronic device 400. Moreover, in some embodiments, electronic device 400 may include one or more additional subsystems that are not shown in FIG. 4. Also, although separate subsystems are shown in FIG. 4, in some embodiments some or all of a given subsystem or component can be integrated into one or more of the other subsystems or component(s) in electronic device 400. For example, in some embodiments instructions 422 is included in operating system 424 and/or control logic 416 is included in interface circuit 418.

Moreover, the circuits and components in electronic device 400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 414 and/or of electronic device 400. The integrated circuit may include hardware and/or software mechanisms that are used for transmitting wireless signals from electronic device 400 and receiving signals at electronic device 400 from other electronic devices. Aside from the mechanisms herein described, radios are generally known in the art and hence are not described in detail. In general, networking subsystem 414 and/or the integrated circuit can include any number of radios. Note that the radios in multiple-radio embodiments function in a similar way to the described single-radio embodiments.

In some embodiments, networking subsystem 414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals).

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 422, operating system 424 (such as a driver for interface circuit 418) or in firmware in interface circuit 418. Alternatively or additionally, at least some of the operations in the communication techniques may be implemented in a physical layer, such as hardware in interface circuit 418.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an interface circuit configured to communicate with a second electronic device, wherein the electronic device is configured to perform operations comprising:
accessing or receiving, associated with the second electronic device, a query or a response to the query;
based on one or more keywords in the query or the response to the query, identifying a type of traffic flow; and
when the type of traffic flow is identified, setting a type of priority for the type of traffic flow.

2. The electronic device of claim 1, wherein the query or the response to the query is accessed in memory in or associated with the electronic device.

3. The electronic device of claim 2, wherein the query or the response to the query is stored in a Domain Name System (DNS) cache.

4. The electronic device of claim 1, wherein the type of traffic flow comprises a voice-call flow that is conveyed in a wireless local area network (WLAN) that is different from a cellular-telephone network, and the WLAN is compatible with an Institute of Electrical and Electronics Engineers (IEEE) 802.11 communication protocol.

5. The electronic device of claim 4, wherein the type of traffic flow comprises VoIP traffic.

6. The electronic device of claim 1, wherein the electronic device comprises an access point.

7. The electronic device of claim 1, wherein the query comprises a DNS query or the response to the query comprises a DNS response.

8. The electronic device of claim 1, wherein the type of priority comprises a voice access category.

9. The electronic device of claim 1, wherein the one or more keywords comprises ‘epdg’ or ‘3gpp.’

10. The electronic device of claim 1, wherein the one or more keywords are included in a fully qualified domain name (FQDN) associated with the query or the response to the query.

11. The electronic device of claim 1, wherein the type of traffic flow is identified based at least in part on a port associated with the type of traffic flow.

12. The electronic device of claim 1, wherein the type of traffic flow is identified based at least in part on a presence of information specifying Encapsulating Security Protocol (ESP) for IP version 4 or version 6 (IPv4 or IPv6) in a header in a packet in the type of traffic flow.

13. The electronic device of claim 1, wherein the operations comprise storing the query or the response to the query.

14. The electronic device of claim 13, wherein the query or the response to the query are stored in a Domain Name Service (DNS) cache.

15. The electronic device of claim 1, wherein the second electronic device comprises a cellular telephone or a Domain Name Service (DNS) server.

16. The electronic device of claim 1, wherein the operations further comprise automatically adding information about an Evolved Packet Data Gateway (ePDG) to a Wi-Fi calling profile of a user.

17. The electronic device of claim 1, wherein the operations further comprise automatically determining a fully qualified domain name (FQDN) used by an Evolved Packet Data Gateway (ePDG).

18. A non-transitory computer-readable storage medium for use in conjunction with an electronic device, the computer-readable storage medium storing program instructions, wherein, when executed by the electronic device, the program instructions cause the electronic device to perform one or more operations comprising:
accessing or receiving, associated with a second electronic device, a query or a response to the query;
based on one or more keywords in the query or the response to the query, identifying a type of traffic flow; and
when the type of traffic flow is identified, setting a type of priority for the type of traffic flow.

19. A method of operating an electronic device for automatically prioritizing a type of traffic flow, comprising:
accessing or receiving, associated with a second electronic device, a query or a response to the query;
based on one or more keywords in the query or the response to the query, identifying the type of traffic flow; and
when the type of traffic flow is identified, setting a type of priority for the type of traffic flow.

20. The method of claim 19, wherein the type of traffic flow comprises a voice-call flow that is conveyed in a wireless local area network (WLAN) that is different from a cellular-telephone network, and the WLAN is compatible with an Institute of Electrical and Electronics Engineers (IEEE) 802.11 communication protocol.
